(19) United States
(12) Patent Application Publication
(10) Pub. No.: US 2026/0005500 A1
(43) Pub. Date: Jan. 1, 2026

(54) ANTI-LEAKAGE PROTECTION DEVICE

(71) Applicant: Shenzhen Huajuxin Technology Co., Ltd., Shenzhen (CN)

(72) Inventor: LEIMING ZHANG, Shenzhen (CN)

(21) Appl. No.: 18/776,610

(22) Filed: Jul. 18, 2024

(30) Foreign Application Priority Data
Jun. 28, 2024 (CN) 202421520993.0

(51) Int. Cl. H02G 3/08; H01R 13/52

(52) U.S. Cl. CPC H02G 3/088; H01R 13/5227

(57) ABSTRACT

An anti-leakage protection device is provided, which includes an inner core body, the inner core body is provided with a socket connected to a null line or a live line; the socket is configured for a live line terminal or a null line terminal to be inserted, and an anti-leakage protection component is further included. The anti-leakage protection component includes a protective device and an electric conductor, the electric conductor is electrically connected to the null line and further provided with an avoidance port corresponding to a position of the socket that is configured for the live line terminal to be inserted; the protective device is provided on an upper side of the inner core body and placed between the inner core body and the electric conductor; the protective device is provided with a protrusion corresponding to the position of the socket and penetrates up and down.

### CROSS-REFERENCE TO RELATED APPLICATIONS

This application claims priority to Chinese Patent Application No. 202421520993.0, filed on June 28, 2024, which is hereby incorporated by reference in its entirety.

### TECHNICAL FIELD

The present disclosure relates to the field of anti-leakage safety technologies, and in particular, to an anti-leakage protection device.

### BACKGROUND

At present, devices used for power extraction or connection can only be used safely and normally in dry environments. However, in a case of accidental immersion, sprinkling, splashing, dampness, or intrusion into other conductive liquids, it is easy to penetrate the charged liquid in the device and may leak electricity to an outside of the device, or the conductive metal parts in the device may oxidize and electrolyze so as to cause poor contact and abnormal temperature rise, so there is a high risk of leakage and electric shock. Besides, the existing physical waterproofing devices in the market have not completely solved this problem from the origin or technical aspect. They can only solve the problem of preventing water leakage or splashing. If the physical waterproofing structure is used for a long time, or if the load connected to the device is fully loaded, it is easy for thermal expansion and contraction to cause aging of the closed structure or loss of sealing function. In addition, the plug-in holes of the physical waterproofing device cannot be sealed because they need to connect to the load equipment. As long as the live line socket of the physical waterproofing device is immersed in water, it will lead to leakage or voltage current caused by the metal parts connected to the live line in the device coming into contact with water after soaking in water, which may spread outward through water as a conductor and cause serious harm to the life and property safety of a user.

In order to solve the above problems, the purpose of the present disclosure is to provide an anti-leakage protection device. An inner core body can provide safety protection when immersed in conductive liquids during use, thereby avoiding leakage and electric shock accidents caused by leakage in such situations.

In order to achieve the above objectives, the technical solution of the present disclosure is as follows: an anti-leakage protection device, including an inner core body, the inner core body is provided with a first socket connected to a null line or a live line; the first socket is configured for a live line terminal or a null line terminal to be inserted, where the anti-leakage protection device further includes an anti-leakage protection component, which includes a protective device and an electric conductor, the electric conductor is electrically connected to the null line and further provided with an avoidance port corresponding to a position of the first socket that is configured for the live line terminal to be inserted; the protective device is provided on an upper side of the inner core body and placed between the inner core body and the electric conductor; the protective device is provided with a first protrusion corresponding to the position of the first socket and the first protrusion penetrates up and down; a rectilinear metric value between an outer side surface of the first protrusion corresponding to the position of the first socket that is configured for the live line terminal to be inserted and a center surface of the live line terminal is greater than or equal to 3 mm; and the rectilinear metric value is a sum of a distance value between an inner surface of the first protrusion and the center surface of the live line terminal, a height value of the first protrusion, and a thickness value of the first protrusion.

In some embodiments of the present disclosure, the upper side of the inner core body is further provided with a second socket configured to connect a ground line and for a ground line terminal to be inserted, and the protective device is provided with a second protrusion corresponding to a position of the second socket that is configured for the ground line terminal to be inserted; the second protrusion penetrates up and down, a rectilinear metric value between an outer surface of the second protrusion and a center surface of the ground line terminal is greater than or equal to 3 mm, and the rectilinear metric value is a sum of a distance value between an inner surface of the second protrusion and the center surface of the ground line terminal, a height value of the second protrusion, and a thickness value of the second protrusion.

In some embodiments of the present disclosure, the protective device is further provided with a support base, the first protrusion is provided on an upper surface of the support base, and the protective device penetrates up and down at a position of the first protrusion.

In some embodiments of the present disclosure, a bottom of the support base is inwardly concave to form an inner concave surface, the first protrusion is provided on the upper surface of the support base, the support base penetrates up and down and to the inner concave surface of the protective device at the position of the first protrusion.

In some embodiments of the present disclosure, the electric conductor is provided with a conductive connector, and a plurality of electric conductors are connected together in a horizontal direction through the conductive connector.

In some embodiments of the present disclosure, the electric conductor includes a first electric conductor, the first electric conductor is a flat plate, the first electric conductor is provided with the avoidance port corresponding to the position of the first socket, the first electric conductor is placed above the protective device, and the avoidance port corresponds to a position of the first protrusion.

In some embodiments of the present disclosure, a straight-line distance between an inner surface of the avoidance port on the first electric conductor and a center surface of the first socket is greater than or equal to 3 mm.

In some embodiments of the present disclosure, the anti-leakage protection device further includes a second electric conductor, the second electric conductor is a flat plate, and the avoidance port corresponding to the position of the first socket is provided on both the second electric conductor and the first electric conductor; the avoidance port of the second electric conductor is installed on the first protrusion of the protective device, the first electric conductor is placed above the protective device, and the avoidance port on the first electric conductor corresponds to the position of the first protrusion.

In some embodiments of the present disclosure, the anti-leakage protection device further includes an installation chamber, the installation chamber includes a socket installation groove and a transition groove, and the inner core body is provided in the socket installation groove.

In some embodiments of the present disclosure, the socket installation groove is filled with sealant in all spaces except for the socket.

In some embodiments of the present disclosure, a surface of the electric conductor is subjected to an inertness treatment.

In some embodiments of the present disclosure, a leakage hole is provided on the transition groove.

In some embodiments of the present disclosure, the anti-leakage protection device further includes an outer shell, where the outer shell is composed of an upper cover and a base, an upper surface of the upper cover is provided with a plug hole, the plug hole corresponds to the position of the first socket, and the installation chamber is provided in the outer shell.

In some embodiments of the present disclosure, the first electric conductor is adhered and fixed on an inner surface of the upper cover, and the avoidance port corresponds to a position of the plug hole.

In some embodiments of the present disclosure, the anti-leakage protection device further includes a power cord, one end of the power cord is fixed on the outer shell and extends into the installation chamber; the power cord is connected to the first socket.

In some embodiments of the present disclosure, the anti-leakage protection device further includes a switch button and a switch assembly, where the switch button is provided on the outer shell and extends into the outer shell, and the power cord is connected to the first socket through the switch assembly.

1. In the anti-leakage protection device in the present disclosure, when the inner core body is accidentally immersed in a conductive liquid, the live line socket will use the conductivity of the conductive liquid to conduct or leak voltage and current to the surrounding conductive liquid area; and when a charged conductive liquid conducts or leaks current and voltage to the outside of the plug-in board, the charged conductive liquid will do work with the electric conductor with null line attribute provided parallel to or above the live line socket. At this time, the internal electric conductor will timely capture or consume the charge conducted by the live line socket to the surrounding area through water after soaking in water, thereby increasing the voltage and current value of the live line socket of the inner core body to the surrounding conductive liquid area. As the electric conductor continuously absorbs and consumes the charge in the charged liquid, it can effectively control and reduce the voltage and current parameters of the water conducted from the socket to the outside of the anti-leakage protection device; thereby avoiding and reducing the risk of accidental contact with people or animals in the conductive liquid area outside the device can also prevent the leakage protection switch from tripping due to leakage and affecting the normal use of load equipment, and further avoid the possibility of damage to electrical equipment caused by leakage tripping.

2. In the anti-leakage protection device of the present disclosure, the electric conductor can be a single-layer or multi-layer structure. When the electric conductor is configured to be one layer, the voltage in the external conductive liquid area of the device can be controlled within 25V; the electric conductor can also be a two-layer or multi-layer structure. When the electric conductor is a two-layer or multi-layer structure, the voltage in the external conductive liquid area of the device can be controlled within 15V, completely lower than and in compliance with national or safety regulations.

### BRIEF DESCRIPTION OF DRAWINGS

FIG. 1 is an internal structure of the present disclosure.

FIG. 2 is a first schematic structural diagram of a protective device in the present disclosure.

FIG. 3 is a second schematic structural diagram the protective device in the present disclosure.

FIG. 4 is a state diagram of a second electric conductor installed on the protective device in the present disclosure.

FIG. 5 is a schematic structural diagram of an installation chamber in the present disclosure.

FIG. 6 is a first state schematic diagram of an inner core body installed in the installation chamber in the present disclosure.

FIG. 7 is a second state schematic diagram of the inner core body installed in the installation chamber in the present disclosure.

FIG. 8 is a fist schematic diagram of an electric conductor of a conductive connector in the present disclosure.

FIG. 9 is a second schematic diagram of the electric conductor of the conductive connector in the present disclosure.

FIG. 10 is a first schematic diagram of a first electric conductor and a second electric conductor in the present disclosure.

FIG. 11 is a second schematic diagram of the first electric conductor and second electric conductor in the present disclosure.

FIG. 12 is a third schematic diagram of the first electric conductor and second electric conductor in the present disclosure.

FIG. 13 is a schematic structural diagram of an outer shell in the present disclosure.

FIG. 14 is schematic structural diagram of an upper cover of the outer shell in the present disclosure.

Numeral reference: inner core body 1, live line socket 1-1, null line socket 1-2, ground line socket 1-3, electric conductor 2, first electric conductor 2-1, second electric conductor 2-2, conductive connector 2-11, protective device 3, avoidance port 3-1, support base 3-2, protrusion 3-3, fixed tab 3-4, inner concave surface 3-5, installation chamber 4, transition groove 4-1, socket installation groove 4-2, leakage hole 4-3, installation screw hole 4-4, clamp groove 4-5, sealant 4-6, base 5, fixed screw hole 5-1, clip 5-2, upper cover 6, first socket area 6-2, second socket area 6-1, switch button 6-3, plug hole 6-4, switch assembly 7.

### DESCRIPTION OF EMBODIMENTS

In order to render the purpose, technical solution, and advantages of the present disclosure clearer and understandable, the following is a further detailed explanation of the present disclosure in combination with the accompanying drawings and embodiments. It should be understood that the specific embodiments described here are only intended to explain the present disclosure and are not intended to limit the present disclosure.

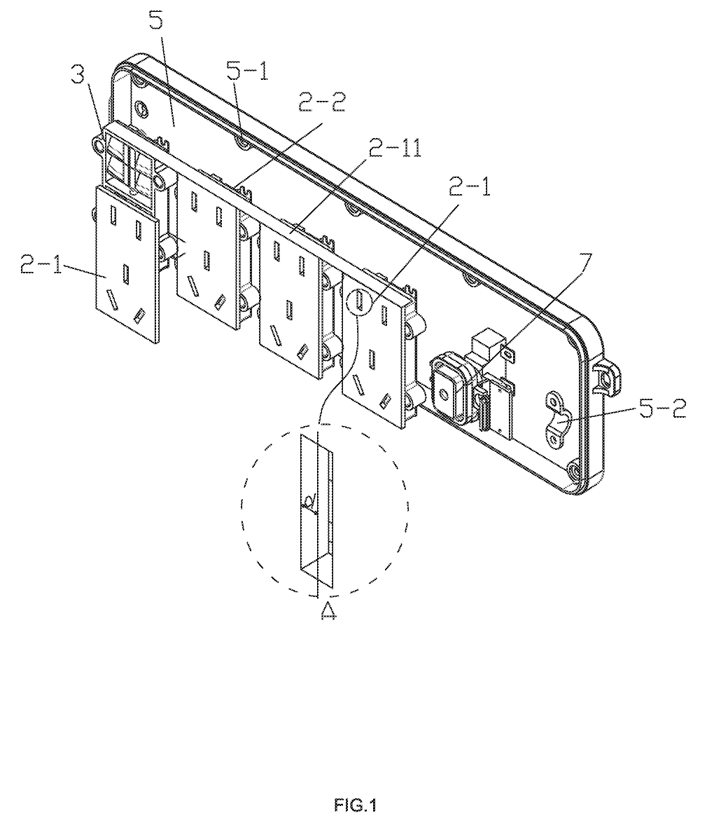

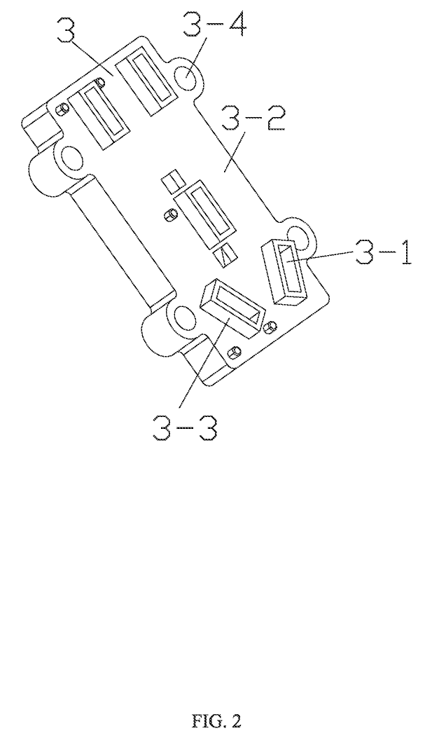

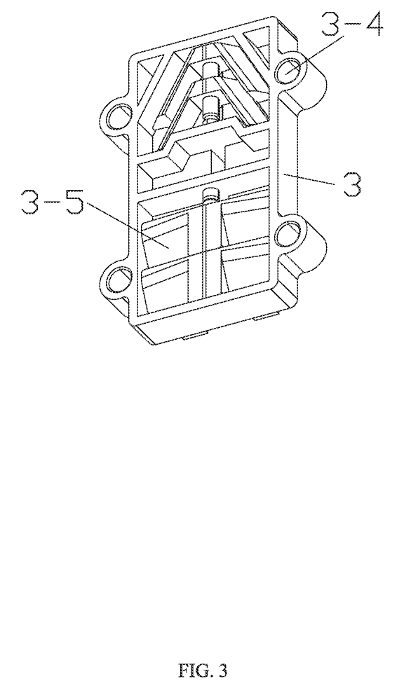

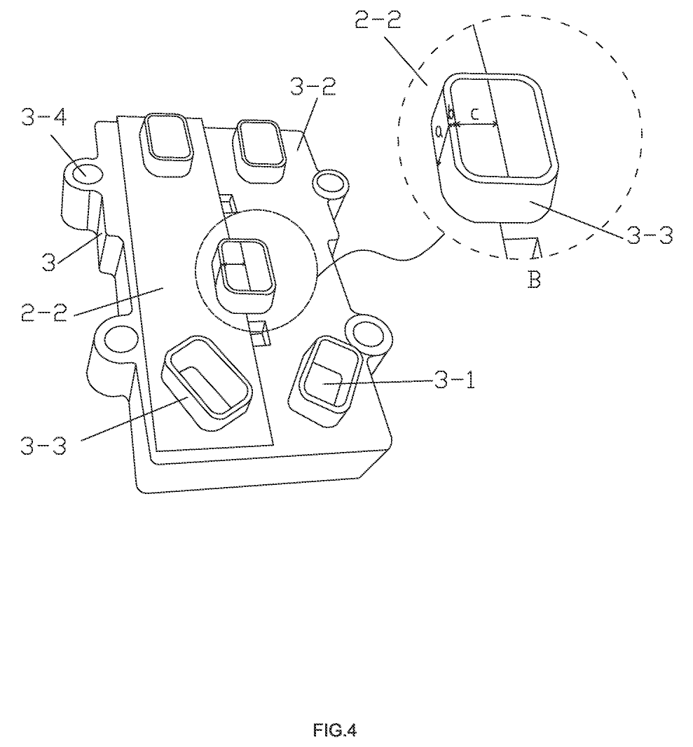

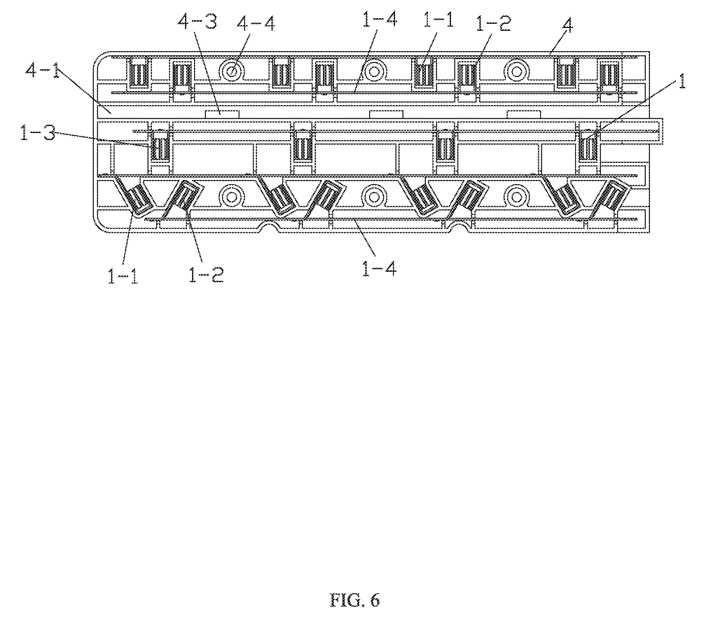

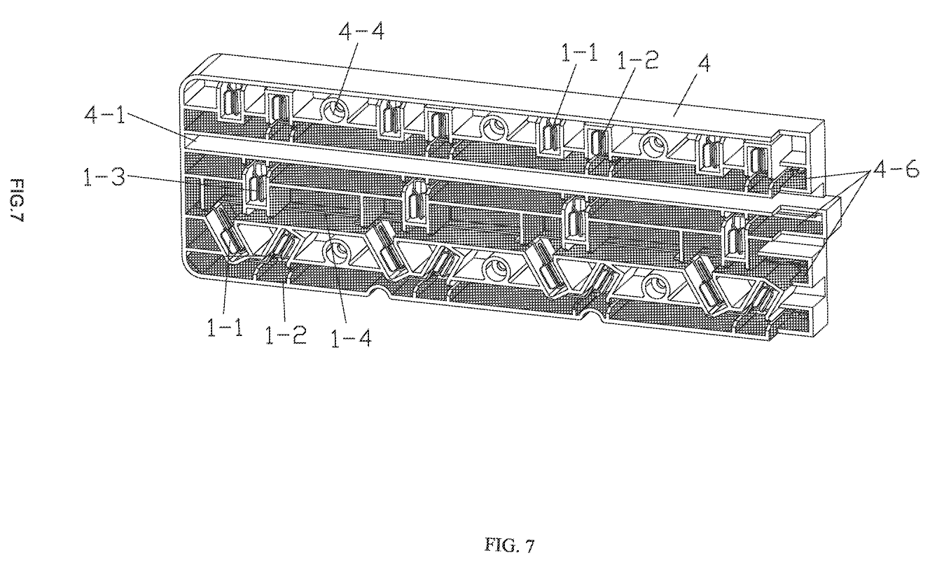

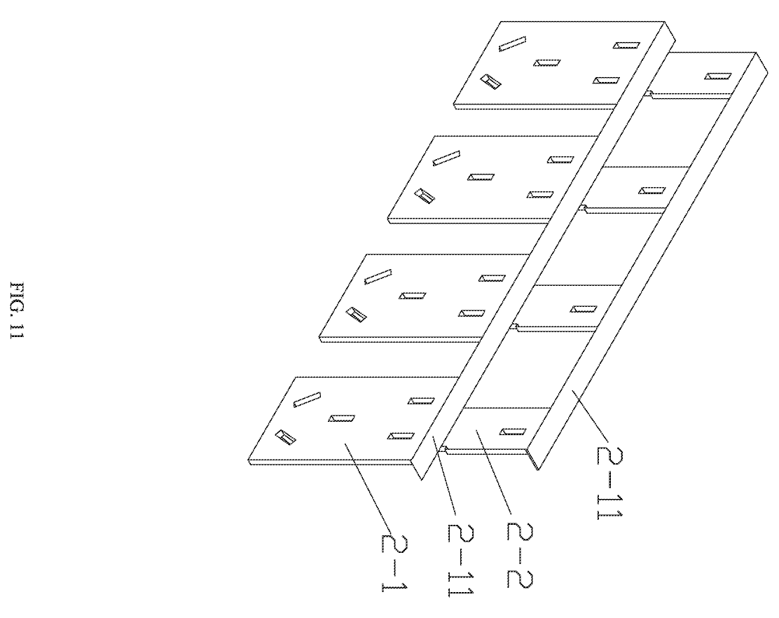

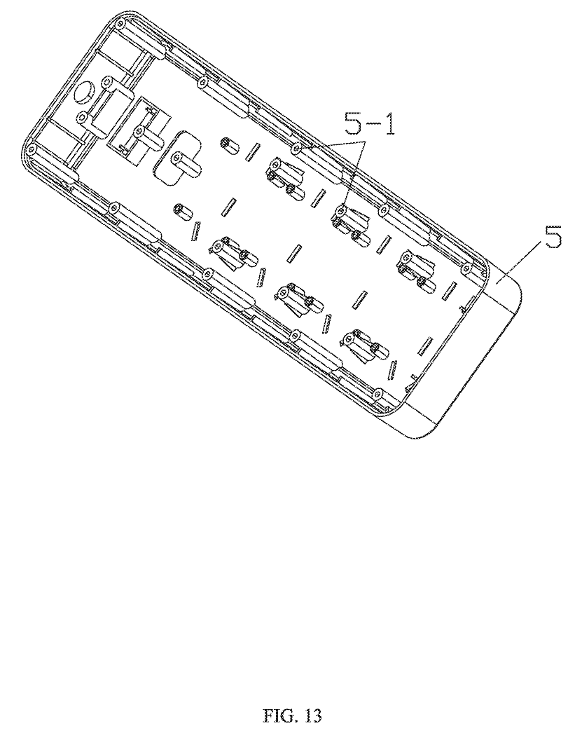

Referring to FIGS. 1 to 14, an anti-leakage protection device includes an inner core body 1, the inner core body 1 is provided with a socket configured to connect with a null line or a live line, the socket connected to the null line is a null line socket 1-2, and the socket connected to the live line is a live line socket 1-1; the live line socket 1-1 is configured for a live line terminal to be inserted, and the null line socket 1-2 is configured for a null line terminal to be inserted. In the present application, the anti-leakage protection device further includes an anti-leakage protection component, the anti-leakage protection component includes a protective device 3 and an electric conductor 2, the electric conductor 2 is electrically connected to the null line; an avoidance port 3-1 corresponding to a position of the live line socket 1-1 that is configured for the live line terminal to be inserted is provided on the electric conductor 2; the protective device 3 is provided on an upper side of the inner core body 1 and placed between the inner core body 1 and the electric conductor 2. A protrusion 3-3 is provided on the protective device 3 that correspond to positions of the live line socket 1-1 and null line socket 1-2, and the protrusion 3-3 penetrates up and down. Specifically, the protrusion 3-3 is a tubular structure that penetrates up and down. During installation, the protrusion 3-3 is arranged downwards, and the inner core body 1 is located below the protective device 3. After installation with the protective device 3, the null line socket 1-2 and the live line socket 1-1 are respectively placed in an inner cavity enclosed by an inner wall of the protrusion 3-3; when the live line terminal is inserted to the live line socket 1-1, a rectilinear metric value between an outer side of the protrusion 3-3 and a center surface of the live line terminal should be greater than or equal to 3 mm; similarly, a rectilinear metric value between an outer surface of the protrusion 3-3 corresponding to the socket configured for the null line terminal to be inserted and a center surface of the null line terminal is greater than or equal to 3mm, the rectilinear metric value is a sum of a distance value between an inner surface of the protrusion and a center surface of the live line terminal, a height value of the protrusion, and a thickness value of the protrusion. As shown in an enlarged aera A in FIG. 4, the height value of the protrusion is a, the thickness value of the protrusion 3-3 is b, and the distance value between the inner surface of the protrusion 3-3 and the center surface of the live line terminal is c. Therefore, the sum of the distance value between the inner surface of the protrusion 3-3 and the center surface of the live line terminal is the sum of a, b, and c. that is, a plus b and plus c is greater than or equal to 3mm.

In an implementation, as a ground line serves as a safety circuit for electricity consumption, the inner core body 1 can also be provided with a ground line socket 1-3 configured to connect to the ground line, the ground line socket 1-3 is configured for a ground line terminal to be inserted; correspondingly, a protrusion 3-3 corresponding to a position of the ground line socket 1-3 is provided on the protective device 3. The protrusion 3-3 is a tubular structure that penetrates up and down. After the installation of the inner core body 1 with the protective device 3 is completed, the ground line socket 1-3 is placed in an inner cavity enclosed by an inner wall of the protrusion 3-3; when the ground line terminal is inserted into the ground line socket 1-3, a rectilinear metric value between an outer surface of the protrusion 3-3 and a center surface of the ground line terminal is greater than or equal to 3mm. The rectilinear metric value is a sum of a distance value between an inner surface of the protrusion 3-3 and the center surface of the ground line terminal, a height value of the protrusion 3-3, and a thickness value of the protrusion 3-3.

In the present application, the protective device 3 is further provided with a support base 3-2, the protrusion 3-3 is provided on an upper surface of the support base 3-2, and the protective device 3 presents up and down at a position of the protrusion 3-3. In an implementation, a bottom of the support base 3-2 is inwardly concave to form an inner concave surface 3-5. The protrusion 3-3 is provided on an upper surface of the support base 3-2, and the support base penetrates up and down and to the inner concave surface 3-5 of the protective device 3 at the position of the protrusion 3-3. When installing the protective device 3, the protrusion 3-3 faces downwards and the support base 3-2 faces upwards. When water or other conductive liquids enter the anti-leakage protection device, the inner concave surface 3-5 of the protective device 3 can accommodate more conductive liquids.

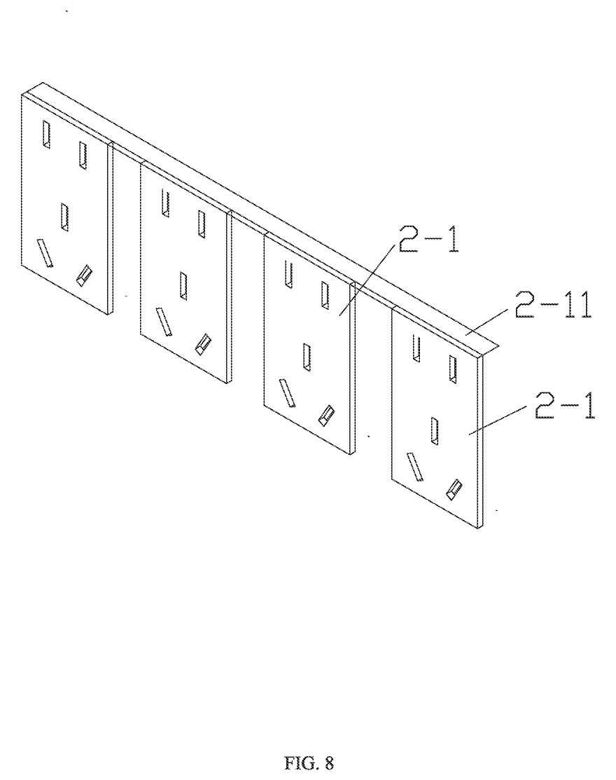

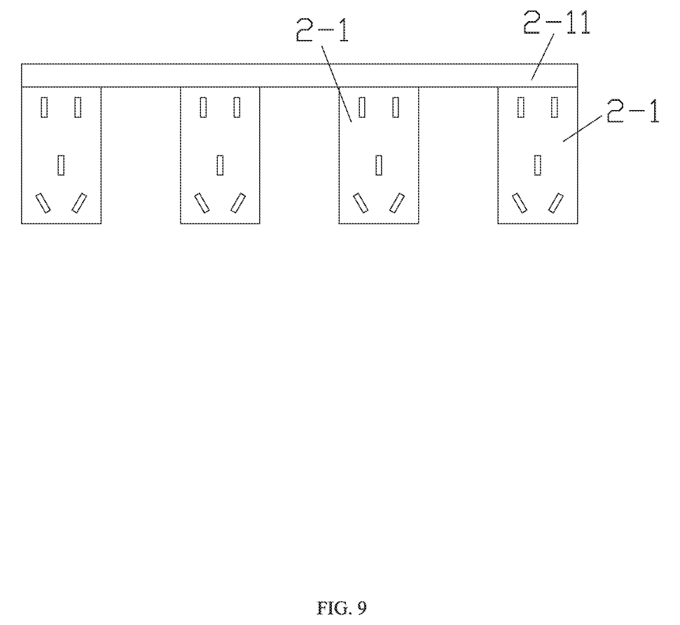

In an implementation, a conductive connector 2-11 is provided on the electric conductor 2, the electric conductor 2 can increase an area of the electric conductor 2, thereby increasing a contact area between the electric conductor 2 and the conductive liquid. Referring to FIG. 9, in an implementation, the conductive connector 2-11 can be in the same plane as the electric conductor 2. Referring to FIG. 8, in an implementation, the conductive connector 2-11 may be located on a side surface of the electric conductor 2, and the conductive connector 2-11 may be perpendicular or not perpendicular to the electric conductor 2. A length of the conductive connector 2-11 is adaptively designed based on the number of the electric conductor 2 that need to be connected in a horizontal direction. The electric conductor 2 can be one or multiple that are integrated with the anti-leakage protection device. A length of the corresponding conductive connector 2-11 can be equal to a total length of several electric conductors 2 plus a horizontal gap of the electric conductor 2. The several electric conductors 2 are connected together in a horizontal direction through the conductive connector 2-11. After installing the several electric conductors 2 with the conductive connector 2-11 and the inner core bodies 1 with a corresponding number, they can meet multiple electrical insertion needs, while increasing the contact area between the electric conductor 2 and the conductive liquid, allowing the charged liquid soaked inside the plug-in board to fully or more contact with the electric conductor 2 to do work, thereby consuming the charge in the charged water or lowering a potential difference of the charged liquid.

In an implementation, the electric conductor 2 includes a first electric conductor 2-1, which is a flat plate. The first electric conductor 2-1 is provided with an avoidance port 3-1 corresponding to a position of the socket, the socket is configured for the live line terminal or null line terminal to be inserted. The socket connected to the null line is the null line socket 1-2, and the socket connected to the live line is the live line socket 1-1. The avoidance port 3-1 corresponds to the positions of the null line socket 1-2 and the live line socket 1-1, respectively; the electric conductor 2 is placed above the protective device 3, and the avoidance port 3-1 corresponds to the position of the protrusion 3-3. In an implementation, a straight-line distance between an inner surface of the avoidance port 3-1 on the first electric conductor 2-1 and a center surface of the socket is greater than or equal to 3 mm, as shown in enlarged A in FIG. 1. The straight-line distance between the inner surface of the avoidance port 3-1 on the first electric conductor 2-1 and the center of the socket is d, that is, d is greater than or equal to 3 mm.

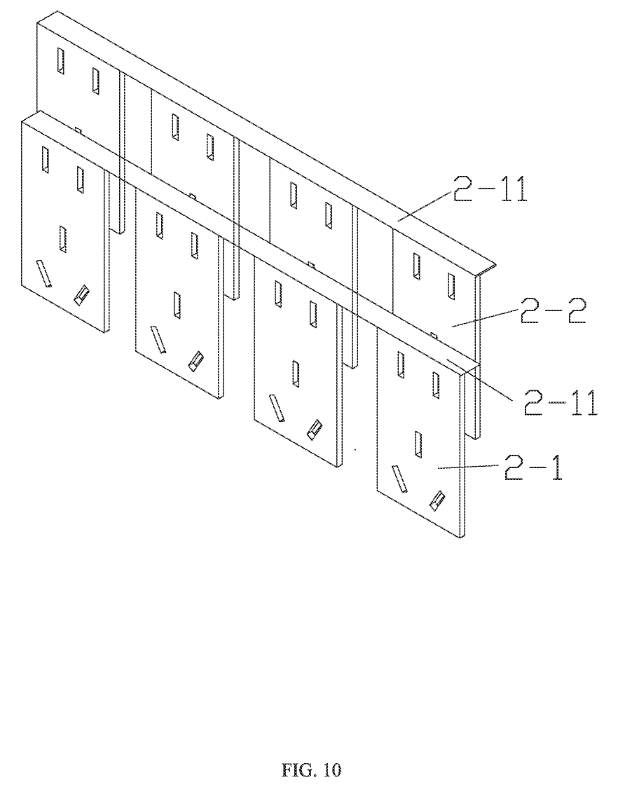

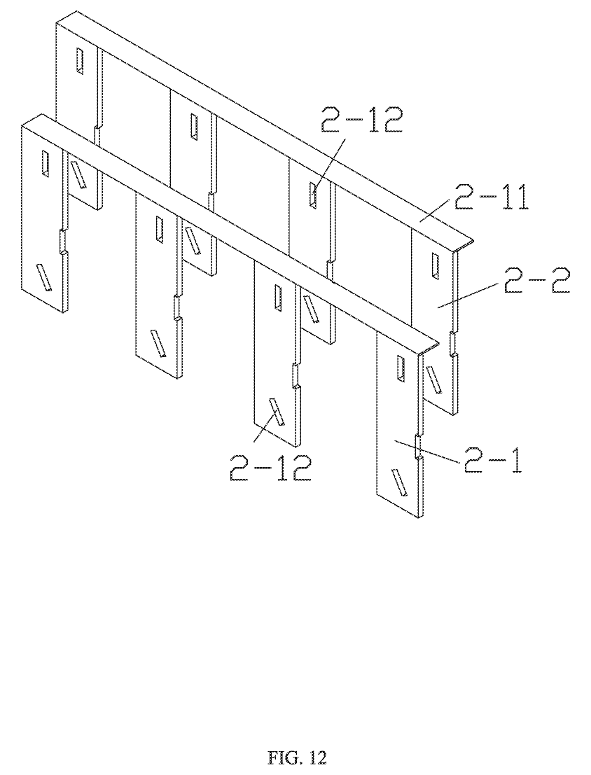

In an implementation, the anti-leakage device of the present application includes a first electric conductor 2-1, and further includes a second electric conductor 2-2. The second electric conductor 2-2 and the first electric conductor 2-1 are both flat plates, an avoidance port 3-1 corresponding to the socket position is both provided on the second electric conductor 2-2 and the first electric conductor 2-1. The socket is configured for the live line terminal or null line terminal to be inserted, and the socket connected to the null line is the null line socket 1-2, and the socket connected to the live line is the live line socket 1-1. The avoidance ports 3-1 respectively correspond to positions of the null line socket 1-2 and the live line socket 1-1. Specifically, during installation, the protrusion 3-3 of the protective device 3 is facing downwards, and the avoidance port 3-1 of the second electric conductor 2-2 is installed on the protrusion 3-3 of the protective device 3. The first electric conductor 2-1 is placed above the protective device 3, and the avoidance port 3-1 on the first electric conductor 2-1 corresponds to the position of the protrusion 3-3. Referring to FIGS. 10 to 12, in the present application, the second electric conductor 2-2 and the first electric conductor 2-1 can have the same shape and size, or they can have different shapes and sizes. That is, if the anti-leakage prevention device requires for a multiple three pin plugs and multiple two pin plugs to be inserted, an arrangement of the sockets is a row of sockets for inserting three pin plugs, and a row parallel to it is a row of sockets for inserting two pin plugs. The second electric conductor 2-2 or the first electric conductor 2-1 can be designed as a flat plate including an avoidance port 3-1 that is only matched with the live line socket 1-1 for inserting the three pin plug and the two pin plug, as shown in FIG. 12, the second electric conductor 2-2 or the first electric conductor 2-1 can also be designed as a flat plate with an avoidance port 3-1 that matches the live line socket, null line socket, and ground line socket for the three pin plug and two pin plug to be inserted, as shown in FIG. 10. Of course, it is also possible to add multiple layers of electric conductor 2 with the avoidance ports 3-1 between the second electric conductor 2-2 and the first electric conductor 2-1. The multi-layer electric conductor 2 can be parallel or non-parallel, and the shape of the multi-layer electric conductor 2 can be the same as that of the second electric conductor 2-2 or the first electric conductor 2-1 to increase the contact area between the electric conductor 2 and the conductive liquid that invades and is between the second electric conductor 2-2 and the first electric conductor 2-1.

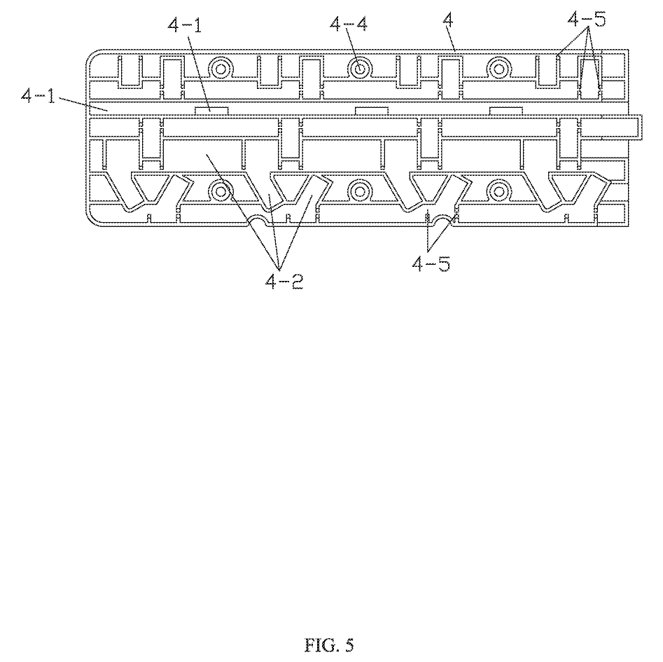

Referring to FIGS. 5 to 7, in order to ensure the safety and stability of the anti-leakage device during use, in the present application, the inner core body 1 can be fixed through the installation chamber 4. The installation chamber 4 includes a socket installation groove 4-2 and a transition groove 4-1, and the inner core body 1 is provided in the socket installation groove 4-2. In the present application, the socket installation groove 4-2 is designed to accommodate a groove shape of the socket and arranged according to angle between each socket and quantity of the sockets. Specifically, the socket installation groove 4-2 can be arranged according to a consistency of the angle of the socket. The socket installation groove 4-2 that require the installation of several sockets with the same angle can be designed in a row. According to the arrangement of the sockets on the inner core body 1, several rows of socket installation grooves 4-2 can be provided on the installation chamber 4 that are consistent with the arrangement of the sockets on the inner core body 1. In an implementation, when the number of sockets is multiple, with the same direction and a certain regular arrangement, a clamp groove 4-5 can be provided on the installation socket. The clamp groove 4-5 is configured to communicate with the groove that accommodates the sockets, and the several regularly arranged sockets are an integrated unit, which can be simultaneously clamped into to the socket installation groove 4-2. In an implementation, a leakage hole 4-3 is provided on the transition groove 4-1. When the conductive liquid enters the anti-leakage protection device of the present application, the conductive liquid can flow out to an outside of the anti-leakage protection device through the leakage hole 4-3. An installation screw hole 4-4 can also be provided on the installation chamber 4, and the installation chamber 4 can be fixed through the installation screw hole 4-4.

In the present application, the socket is made of conductive metal. When the several sockets that are regularly arranged are integrated made, except for a socket part configured for inserting and connecting an external conductive terminal such as live line terminal or null line terminal, the other conductive metal parts are useless and exposed. When the conductive liquid enters the installation chamber 4, it increases a risk of conductivity. Therefore, in an implementation, when the socket is installed in the socket installation groove 4-2, the remaining space in the socket installation groove 4-2, except for the socket, is filled with sealant 4-6, which can reduce a contact area between the conductive metal and the conductive liquid and reduce the risk of conductivity. The anti-leakage protection device of the present application relates to the safety of electrical appliances. Therefore, the sealant 4-6 can be filled with silicone or epoxy resin to seal the space inside the socket installation groove 4-2 except for the socket. Flame retardant sealant can also be used, such as flame-retardant silicone or flame-retardant epoxy resin filling adhesive with flame-retardant properties, which not only provides sealing effect but also flame-retardant effect.

The anti-leakage protection device of the present application further includes an outer shell, the outer shell is composed of an upper cover 6 and a base 5. An upper surface of the upper cover 6 is provided with a plug hole 6-4, the plug hole 6-4 corresponds to the position of the socket; specifically, during installation, the inner core body 1 is installed in the socket installation groove 4-2 of the installation chamber 4, the socket is located in a groove of the socket installation groove 4-2, and the installation chamber 4 is fixed in a space formed an interior of the outer shell. In an implementation, in order to prevent the installation chamber 4 from shaking during use, a fixed screw hole 5-1 can be provided on the upper cover 6 to fix the installation chamber 4. The installation screw hole 4-4 is aligned with the fixed screw hole 5-1, and the installation chamber 4 is fixed on the upper cover 6 through a cooperation between the screw and screw hole. In an implementation, the first electric conductor 2-1 can be adhered to and fixed to an inner surface of the upper cover 6 during installation, and the avoidance port 3-1 corresponds to the position of the plug hole 6-4. It can be fixed to the upper cover 6 through the installation chamber 4, and the first electric conductor 2-1 can be placed above the protective device 3 and attached to the upper cover 6. After the installation chamber 4 is fastened to the upper cover 6, the installation position of the first electric conductor 2-1 is also relatively fixed. In the present application, the electric conductor 2 can also be directly placed on an inner wall of the upper cover 6 in a semi enclosed form. Specifically, during installation, the inner core body 1 can be placed inside the installation chamber 4 first, and then the second electric conductor 2-2 is attached to the protective device 3. The avoidance port 3-1 on the second electric conductor 2-2 correspond to the protrusion 3-3 on the protective device 3. The protective device 3 should be inverted, with the protrusion 3-3 facing downwards. Then, the fixed tab 3-4 is aligned with the installation screw hole 4-4, and the protective device 3 is fixed on the installation chamber 4. Then, the first electric conductor 2-1 is placed on the protective device 3 and attached to the upper cover 6, the installation screw hole 4-4 is aligned with the fixed screw hole 5-1, and the installation chamber 4 is fixed on the upper cover. 6.

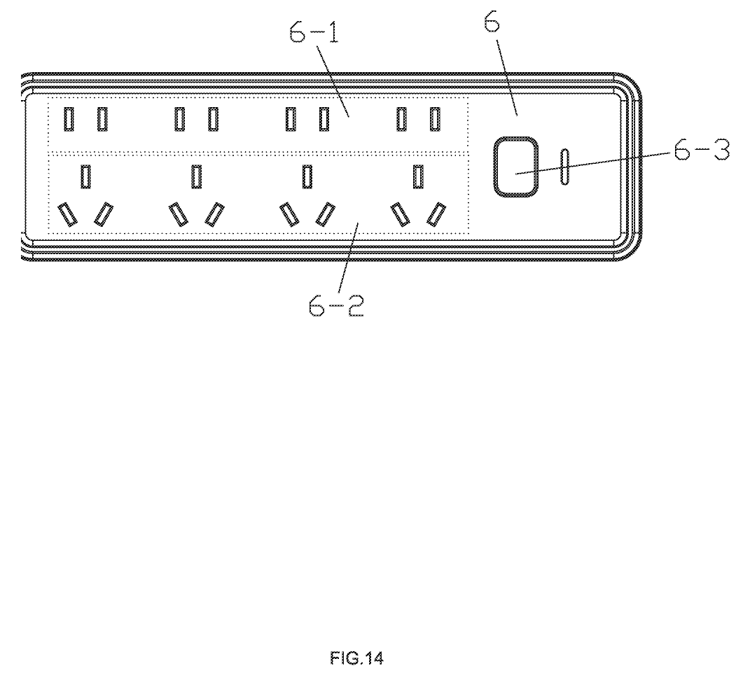

Refer to FIG. 14, the upper cover 6 is provided with a first socket area 6-2 corresponding to the external two pin plug and a second socket areas 6-1 corresponding to the external three pin plug. Correspondingly, on the inner core body 1, the null line sockets 1-2, live line sockets 1-1, and ground line sockets 1-3 are provided in the first socket area 6-2. The second socket area 6-1 is provided with the null line socket 1-2 and the live line socket 1-1; a plurality of first socket areas 6-2 and a plurality of first socket areas 6-2 are regularly arranged in a horizontal direction. The installation chamber 4 can be provided with a plurality rows of socket installation grooves 4-2 that are consistent with the layout of the sockets on the inner core body 1. The first socket area 6-2 can be configured for the three-pin plug to be inserted, and the second socket area 6-1 can be configured for the two pin plug to be inserted.

In the present application, a power cord is externally connected to the socket, and a clip 5-2 is provided on the base 5 to fix the power cord. One end of the power cord is fixed on the outer shell, and then extends into the installation chamber 4 and connects to the socket. In an implementation, a switch button 6-3 can be further provided on the outer shell, and a switch assembly 7 can be provided on the base 5. The switch button 6-3 can extend into the installation chamber 4, and the power cord is connected to the socket through the switch assembly 7.

In the present application, due to the socket configured to connect the live line, null line, and ground line being fixed on the installation chamber 4 in the anti-leakage protection device, and the sockets are surrounded by the four sides of the plug-in board outer shell, after connecting the live line terminal or null line terminal, the anti-leakage protection device is connected to the power supply. Therefore, after the leakage protection device invades the conductive liquid, when the conductive liquid flows through the live line terminal, it becomes a charged liquid. The only way for the charged liquid to transmit voltage to the outside of the anti-leakage protection device is through the plug holes 6-4 on the outer cover 6. In an implementation, a surface of the electric conductor 2 in the present application is subjected to an inertness treatment, such as nickel plating, so as to avoid the risk of poor contact caused by electrolysis or oxidation when the electric conductor 2 is immersed in the conductive liquid and interacts with the charged liquid. The inertness treatment of the electric conductor 2 can extend the safe use and service life of this plug-in board.

When the conductive liquid invades the anti-leakage device of the present application, the electric conductor 2 divides the conductive liquid in the anti-leakage device into upper and lower parts, and both conductive surfaces can fully contact and work with the divided upper and lower parts of the charged liquid, consuming the voltage of the charged liquid to lower the potential difference of the charged liquid. In this case, only a small amount of charged liquid will conduct current and voltage to an upper space of the anti-leakage device from the avoidance port 3-1 of the electric conductor 2.

When the second electric conductor 2-2 is installed at the position of the protrusion 3-3 of the protective device 3, the conductive liquid passes through the second electric conductor 2-2 to lower the potential difference of the charged liquid. The conductive liquid flows into the upper space of the anti-leakage device from the protrusion 3-3 that penetrates up and down of the protective device 3, and conduct current and voltage. During this process, it avoids the charged liquid from conducting current and voltage in a straight line through the plug hole 6-4 of the outer shell of the anti-leakage device to the external water area, and can allow residual charged water to flow out of the avoidance port 3-1 of the second electric conductor 2-2 to transmit conduction voltage to the socket of the plug-in board outer shell. When the conductive voltage is dispersed, it flows through the first electric conductor 2-1. In addition, by utilizing the space occupied by the protective device 3 to compress the water inside the plug-in board, the volume and charged amount of the charged liquid are reduced, allowing the area flowing into the upper space, that is, the charged liquid between the protective device 3 and the first electric conductor 2-1, to fully contact and do work with the first electric conductor 2-1. The first electric conductor 2-1 works again with the residual charged liquid flowing out from the protrusion 3-3 of the second electric conductor 2-2, further consuming and lowing the current and voltage of the charged liquid, ultimately achieving a voltage of less than 36V transmitted to the external conductive liquid area through the outer shell socket of the anti-leakage protection device. In an actual testing, the voltage in the external conductive liquid area of the anti-leakage protection device of the present application is less than 25V. The ground line terminal inside the anti-leakage protection device detects that the current of the charged liquid in the anti-leakage protection device is less than 10 milliamperes after being immersed in conductive liquid, which is lower than the current standard of leakage protection and leakage braking. This fully ensures that the anti-leakage protection device can work normally by connecting the load that receives electricity through the anti-leakage protection device after being immersed in conductive liquid.

In the present application, the electric conductor 2 can be made of copper or aluminum sheets, or other conductive materials.

It should be noted that the conductive liquid mentioned in the present application can be general domestic water or other conductive liquids without corrosive liquids. The anti-leakage protection device of the present application cannot be immersed in sewage, salt water, carbonate or corrosive liquids.

The above are only preferred embodiments of the present disclosure and are not intended to limit the present disclosure. Any modifications, equivalent replacements, and improvements made within the spirit and principles of the present disclosure should be included within the protection scope of the present disclosure.

What is claimed is:

1. An anti-leakage protection device, comprising an inner core body, wherein the inner core body is provided with a first socket connected to a null line or a live line; the first socket is configured for a live line terminal or a null line terminal to be inserted,
wherein the anti-leakage protection device further comprises an anti-leakage protection component, which comprises a protective device and an electric conductor, the electric conductor is electrically connected to the null line and further provided with an avoidance port corresponding to a position of the first socket that is configured for the live line terminal to be inserted; the protective device is provided on an upper side of the inner core body and placed between the inner core body and the electric conductor; the protective device is provided with a first protrusion corresponding to the position of the first socket and the first protrusion penetrates up and down; a rectilinear metric value between an outer side surface of the first protrusion corresponding to the position of the first socket that is configured for the live line terminal to be inserted and a center surface of the live line terminal is greater than or equal to 3 mm; and the rectilinear metric value is a sum of a distance value between an inner surface of the first protrusion and the center surface of the live line terminal, a height value of the first protrusion, and a thickness value of the first protrusion.

2. The anti-leakage protection device according to claim 1, wherein the upper side of the inner core body is further provided with a second socket configured to connect a ground line and for a ground line terminal to be inserted, and the protective device is provided with a second protrusion corresponding to a position of the second socket that is configured for the ground line terminal to be inserted; the second protrusion penetrates up and down, a rectilinear metric value between an outer surface of the second protrusion and a center surface of the ground line terminal is greater than or equal to 3 mm, and the rectilinear metric value is a sum of a distance value between an inner surface of the second protrusion and the center surface of the ground line terminal, a height value of the second protrusion, and a thickness value of the second protrusion.

3. The anti-leakage protection device according to claim 1, wherein the protective device is further provided with a support base, the first protrusion is provided on an upper surface of the support base, and the protective device penetrates up and down at a position of the first protrusion.

4. The anti-leakage protection device according to claim 3, wherein a bottom of the support base is inwardly concave to form an inner concave surface, the first protrusion is provided on the upper surface of the support base, the support base penetrates up and down and to the inner concave surface of the protective device at the position of the first protrusion.

5. The anti-leakage protection device according to claim 1, wherein the electric conductor is provided with a conductive connector, and a plurality of electric conductors are connected together in a horizontal direction through the conductive connector.

6. The anti-leakage protection device according to claim 1, wherein the electric conductor comprises a first electric conductor, the first electric conductor is a flat plate, the first electric conductor is provided with the avoidance port corresponding to the position of the first socket, the first electric conductor is placed above the protective device, and the avoidance port corresponds to a position of the first protrusion.

7. The anti-leakage protection device according to claim 6, wherein a straight-line distance between an inner surface of the avoidance port on the first electric conductor and a center surface of the first socket is greater than or equal to 3 mm.

8. The anti-leakage protection device according to claim 6, further comprising a second electric conductor, the second electric conductor is a flat plate, and the avoidance port corresponding to the position of the first socket is provided on both the second electric conductor and the first electric conductor; the avoidance port of the second electric conductor is installed on the first protrusion of the protective device, the first electric conductor is placed above the protective device, and the avoidance port on the first electric conductor corresponds to the position of the first protrusion.

9. The anti-leakage protection device according to claim 1, further comprising an installation chamber, which comprises a socket installation groove and a transition groove, and the inner core body is provided in the socket installation groove.

10. The anti-leakage protection device according to claim 9, wherein the socket installation groove is filled with sealant in all spaces except for the socket.

11. The anti-leakage protection device according to claim 1, wherein a surface of the electric conductor is subjected to an inertness treatment.

12. The anti-leakage protection device according to claim 9, wherein a leakage hole is provided on the transition groove.

13. The anti-leakage protection device according to claim 9, further comprising an outer shell, wherein the outer shell is composed of an upper cover and a base, an upper surface of the upper cover is provided with a plug hole, the plug hole corresponds to the position of the first socket, and the installation chamber is provided in the outer shell.

14. The anti-leakage protection device according to claim 8, wherein the first electric conductor is adhered and fixed on an inner surface of the upper cover, and the avoidance port corresponds to a position of the plug hole.

15. The anti-leakage protection device according to claim 13, further comprising a power cord, one end of the power cord is fixed on the outer shell and extends into the installation chamber; the power cord is connected to the first socket.

16. The anti-leakage protection device according to claim 13, further comprising a switch button and a switch assembly, wherein the switch button is provided on the outer shell and extends into the outer shell, and the power cord is connected to the first socket through the switch assembly.
